(19) United States
(12) Patent Application Publication
(10) Pub. No.: US 2003/0079638 A1
(43) Pub. Date: May 1, 2003

(54) Personalized photo process for containers

(76) Inventor: Don R. Burnett, Gig Harbor, WA (US)

Correspondence Address: Mark L. Lorbiecki, BLACK LOWE & GRAHAM PLLC, 816 Second Avenue, Seattle, WA, 98104, US

(21) Appl. No.: 10/046,438

(22) Filed: Oct. 26, 2001

(51) Int. Cl. B05D 5/00; B41F 1/16

(52) U.S. Cl. 101/492

(57) ABSTRACT

A system and method for applying a digital image to a metal container. The method includes retrieving a digital image using a computer, adjusting the digital image according to a desired location on a metal container, printing the digital image onto heat transfer paper using dye sublimation ink, and pressing the printed image onto the desired surface of the container.

### FIELD OF THE INVENTION

This invention relates generally to printing, and more specifically to printing images onto metal containers.

### BACKGROUND OF THE INVENTION

Metal tins have been a traditional holiday gift. Filled with cookies, candies, or nuts, the holiday tin enjoys the favor of many a gift giver. Even outside of the holiday season, these metal tins serve as pencil boxes, crayon keepers, and the regular receptacle for miscellaneous items.

Rather than to leave the tins in their “bright” or unpainted condition, manufacturers of such tins have lithographed images on the metal before forming it as a tin. The lithograph process fuses the image to the metal, then the metal is bent and stretched according the desired finished shape and dimensions. The economy of such a process has been in the mass production of finished tins. For that reason, only very generic themes have warranted production in the numbers necessary to make production economical.

Vendors have sought the opportunity to personalize gifts. Personalized gifts come in many variations. For example, there is presently the ability to apply personalized photos onto coffee mugs. However, there does not exist a process for efficiently and effectively placing personalized photos or sayings onto decorative gift tins, such as those used to hold cookies or candy products.

### SUMMARY OF THE INVENTION

The present invention is a system and method for applying a digital image to a metal container. The method includes retrieving a digital image using a computer, adjusting the digital image according to a desired location on a metal container, printing the digital image onto heat transfer paper using dye sublimation ink, and pressing the printed image onto the desired surface of the container.

In accordance with further aspects of the invention, the method further allows insertion of a textual or graphical object onto the digital image before printing.

In accordance with other aspects of the invention, before pressing, a base paint coat and a clear polyester coat are applied to the surface of the container.

In accordance with still further aspects of the invention, pressing includes applying heat for a set amount of time based on the type of dye sublimation ink and heat transfer paper used.

In accordance with yet other aspects of the invention, the digital image is a digital photo or a digitized image.

In accordance with still another aspect of the invention, the metal container is a tin container.

As will be readily appreciated from the foregoing summary, the invention provides an efficient and effective method of placing personalized photos or sayings onto decorative gift tins.

### BRIEF DESCRIPTION OF THE DRAWINGS

The preferred and alternative embodiments of the present invention are described in detail below with reference to the following drawings.

FIG. 1 is a perspective view of a product formed in accordance with the present invention process;

FIG. 2 is a diagram of an example system used to perform the printing process of the present invention; and

FIG. 3 is a flow diagram of an example process of the present invention.

### DETAILED DESCRIPTION OF THE PREFERRED EMBODIMENT

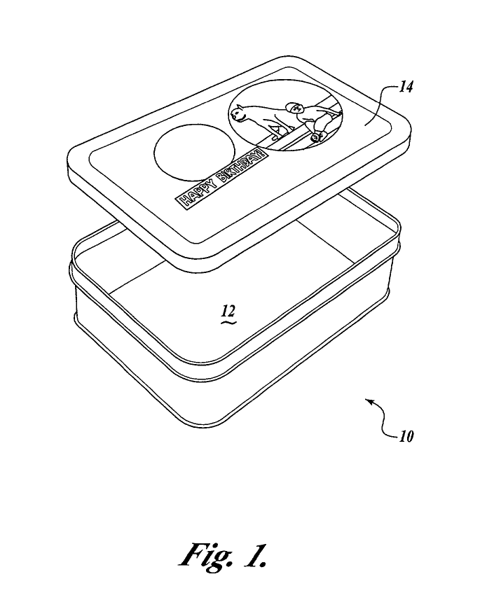

The present invention provides a process for placing digital photos or images onto the side or lid of a metal container. The process of the present invention can also be applied to tin, steel or other alloy containers. The shape of the container may vary. For example, various sized cylindrical or box-shaped containers may be used. FIG. 1 illustrates an example container 10 that includes a base portion 12 and a lid 14. The process of the present invention takes a digital image, such as a digital or digitized photo, generated by a user and transfers it onto a desired location on the outside of the base portion 12 or lid 14.

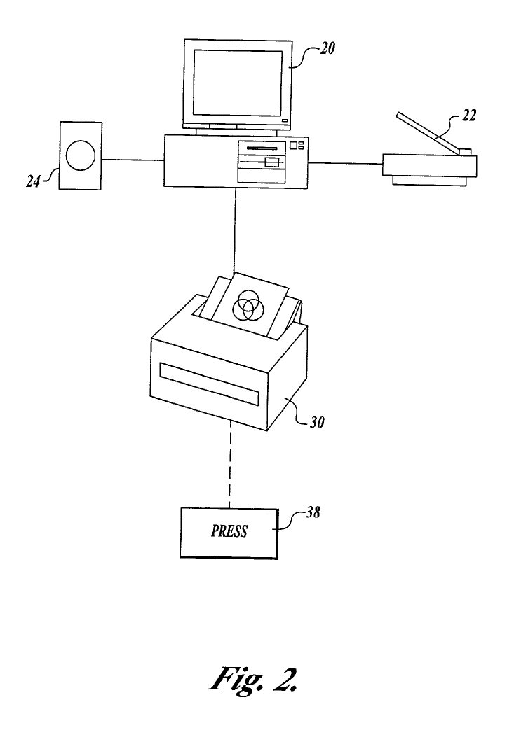

FIG. 2 illustrates some of the components used for performing the process of the present invention. An example system utilizes a main computer 20 possibly coupled to a scanner 22 or a digital camera 24. The computer 20 allows a user to generate a digital photo generated by the camera 24, a digital image scanned by the scanner 22, or a digital image created by the user using a graphical program application using a user interface (not shown). Once the user has selected or generated the desired digital photo or image, the user prints the desired image on a printer 30 that is coupled to the computer 20. The printer 30 is preferably an ink jet printer that uses dye sublimation ink and prints the desired images onto sublimation heat transfer paper. The printed image is preferably printed as an inverse image (not a negative) of the actual image. This allows the image to be properly oriented on the container.

The printed photo or image is then brought to a press 38 that applies the printed photo or image onto a container. The press 38 is preferably a pneumatic heat press that presses the printed image against a surface of the container at an approximate temperature of 375 degrees for about 90 seconds or the temperature and time necessary to transfer the image from the heat transfer paper onto the surface of the container. Not shown in FIG. 2 are the components of the system that cut and form the metal of the container, apply a base paint coat to the surface of the container, and apply a clear polyester base coat to the applied base paint coat.

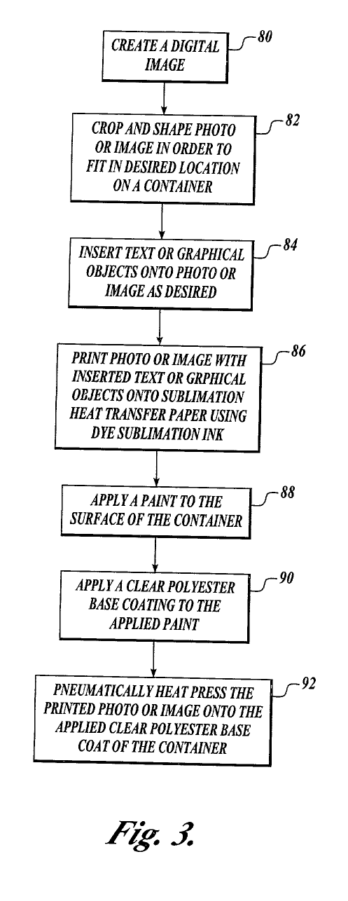

FIG. 3 illustrates a preferred process performed by the components illustrated in FIG. 2. First, at block 80, a digital image is created. This can be done by receiving a digital image from a digitizing source, such as a digital scanner, a scanner, a remote source, such as an Internet site, or some other digitizing source, or generating a digital image using a graphics program. A photo is digitized, or an image is digitized by a scanning process or created in a graphical application program. Next, at block 82, the digitized photo or image is cropped or shaped in order to fit into a desired location on a container. In one embodiment, the cropped or shaped image is converted into a jpg (JPEG) format using 24-bit color (CMYK or RGB) using an image application program preferably operating on the computer 20. For example, if the digital image measures 8 inches by 10 inches and the surface of the container lid where the image is to be placed measures 4 by 5 inches, the step performed block 82 reduces the size of the digital image in order for it to fit into the smaller surface area of the lid. Next, at block 84, text or graphical objects are inserted onto the digitized photo or image as desired by the recipient of the finished product. The text or graphical objects may be selected from a predefined set or maybe created using text or graphical application program. Next, at block 86, the digital photo or image with the inserted text or graphical objects is printed onto sublimation heat transfer paper using dye sublimation ink.

Before the printed image can be applied to the container, a paint is applied to the surface of the container, see block 88. Next, at block 90, a clear polyester base coating is applied over the applied paint. Finally, at block 92, a pneumatic heat press applies the printed photo or image onto the clear polyester base coat of the container.

While the preferred embodiment of the invention has been illustrated and described, as noted above, many changes can be made without departing from the spirit and scope of the invention. Accordingly, the scope of the invention is not limited by the disclosure of the preferred embodiment.

The embodiments of the invention in which an exclusive property or privilege is claimed are defined as follows:

1. A method for applying a digital image to a metal container, the method comprising:
retrieving a digital image using a computer;
adjusting the digital image according to a desired location on a metal container;
printing the digital image onto heat transfer paper using dye sublimation ink; and
pressing the printed image onto the desired surface of the container.

2. The method of claim 1, further comprising inserting at least one of a textual or graphical object onto the digital image before printing.

3. The method of claim 1, further comprising:
applying a base paint to the surface of the container; and
applying a clear polyester base coat over the applied paint.

4. The method of claim 1, wherein pressing comprises applying heat for a set amount of time based on the type of dye sublimation ink and heat transfer paper used.

5. The method of claim 1, wherein the digital image is at least one of a digital photo or a digitized image.

6. The method of claim 1, wherein the metal container is a tin container.

7. A system for applying a digital image to a metal container, the system comprising:
a user interface;
a processor configured to retrieve a digital image and adjust the digital image according to a desired location on a metal container using the user interface;
a printer coupled to the processor and configured to print the digital image onto heat transfer paper using dye sublimation ink; and
a press configured to press the printed image onto the desired surface of the container.

8. The system of claim 7, wherein the processor is further configured to insert at least one of a textual or graphical object onto the digital image before printing.

9. The system of claim 7, further comprising:
a component configured to apply a base paint to the surface of the container; and
a component configured to apply a clear polyester base coat over the applied paint.

10. The system of claim 7, wherein the digital image is at least one of a digital photo or a digitized image.

11. The system of claim 7, wherein the metal container is a tin container.

12. A metal container imprinted by a method comprising:
retrieving a digital image using a computer;
adjusting the digital image according to a desired location on a metal container;
printing the digital image onto heat transfer paper using dye sublimation ink; and
pressing the printed image onto the desired surface of the container.

13. The container of claim 12, wherein the method further comprises inserting at least one of a textual or graphical object onto the digital image before printing.

14. The container of claim 12, wherein the method further comprises:
applying a base paint to the surface of the container; and
applying a clear polyester base coat over the applied paint.

15. The container of claim 12, wherein pressing comprises applying heat for a set amount of time based on the type of dye sublimation ink and heat transfer paper used.

16. The container of claim 12, wherein the digital image is at least one of a digital photo or a digitized image.

17. The container of claim 12, wherein the metal container is a tin container.
